(19) United States
(12) Patent Application Publication
(10) Pub. No.: US 2024/0245491 A1
(43) Pub. Date: Jul. 25, 2024

(54) LOW FRICTION LIGATION ORTHODONTIC INSTRUMENT

(71) Applicant: LEONIDAS ATHANASIADIS, VEROIA (GR)

(72) Inventor: LEONIDAS ATHANASIADIS, VEROIA (GR)

(21) Appl. No.: 18/564,346

(22) PCT Filed: May 19, 2022
(86) PCT No.: PCT/GR2022/000029

§ 371 Date: Nov. 27, 2023

(30) Foreign Application Priority Data
Jun. 8, 2021 (GR) 20210100377

(51) Int. Cl. A61C 7/02

(52) U.S. Cl. CPC A61C 7/026

(57) ABSTRACT

Hand held low friction ligation orthodontic instrument including a handle (12) on one end and an elongated shaft (8) extending longitudinally on the other end. The shaft comprises a copper nickel titanium metal alloy with modified memory characteristics, capable of great elasticity and flexibility. The shaft ligated simultaneously with an orthodontic wire into the bracket slot using a wire ligature provides after its pull a low friction wire ligature (11).

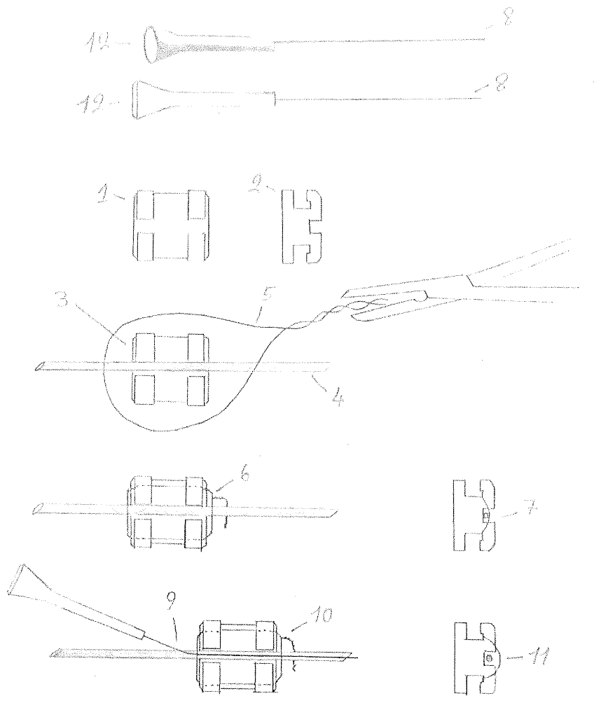

The present invention relates to an intraoral orthodontic device used in the process of ligating fixed orthodontic appliances (braces) and in particular is inserted during the ligation phase between the main orthodontic wire and the bracket

Orthodontic tooth movement is performed with the use of specialized materials, which allow the application of constant and continuous pressure on them, so that they gradually move to their ideal position.

In orthodontics there are two types of brackets.

The traditional or conventional brackets (1,2), in which there are three main components used to allow the teeth to move, namely the bracket itself, which is placed on the tooth (3), the wire that runs through the bracket slot (4) and exerts a corrective force on teeth and the ligation (5), which usually consists of elastic or metal material—in this image it is shown a wire ligature that ligates the orthodontic wire into the bracket slot.

The manufacturing process of the elastic ligatures is simple and economic, however after a short period of time in mouth they collect food residues and bacterial plaque, they degrade from the saliva losing their elasticity and finally they discolor (turning yellow).

On the contrary, wire ligatures (5) do not discolor, they have greater stability in time than elastic ligatures and they do not collect easily food residues. However, the ligation and removing process is time consuming.

The prior art of conventional brackets problem is that because of the elastic or wire ligature which holds the orthodontic wire into the bracket slot, it involves a lot of friction (7), which has as a result slower tooth movement and greater patient discomfort.

The other type are the Self Ligated Brackets. This system uses a door or a clip mechanism, that opens and closes in order to insert and remove the archwire to and from the bracket slot.

They eliminate the need of elastic and wire ligatures, instead they use a permanently installed movable component, a door or a clip to entrap the archwire into the bracket slot. Once the archwire is placed, a gap is created between the slot and the door thus allowing the archwire to freely move through the bracket with significantly low resistance and low friction.

Unlike the conventional-classic brackets, when ligated with elastic or wire ligatures, they tend to tightly hold the archwire, provoking resistance and friction, impeding the archwire to freely move-to freely slide in the bracket slot.

An orthodontic archwire especially in the initial stages of treatment works by returning to its original shape, thanks to its elasticity and the teeth eventually follow that shape shifting into their proper positions. It's quite evident, that with less resistance, the archwire returns to its original form in less amount of time and the teeth move to their desired positions.

It has also been claimed by many doctors that the free sliding of the orthodontic archwire implies faster and more comfortable tooth movement.

The present invention has been devised to overcome the high friction ligation problem in the conventional brackets described above, in such a way as to allow the orthodontic archwire (4) to freely slide into the bracket slot (11).

The present invention is an orthodontic low friction ligation tool comprising a handle (12) at one end, and an elastic wire on the other end (8).

The low profile enables it to fit comfortably between the teeth and cheek.

This unique feature allows the one end of the instrument, namely the wire, specifically the nickel titanium thermoactivated wire (8) to be placed inside the conventional bracket slot together with the orthodontic archwire (9) and ligated using a wire ligature (10).

The purpose of the thermoactivated wire (8) is that it can withstand deformation under mechanical stress and it recovers its shape fully once the stress is removed, it can repeatedly bear being crooked and not fracture by fatigue.

Specifically, it allow the orthodontist by pulling the handle of the device on the one end, removing the other end of the device namely the wire (8), leaving a gap in the bracket slot (11), creating a low friction wire ligature tie, so that the main orthodontic wire can move with low resistance-low friction thanks to the gap created.

This device can be used on any conventional metal or aesthetic bracket, labial (in front of the teeth) or lingual (in back of the teeth).

Using it on aesthetic ceramic or composite brackets together with the already existing in market tooth color coated wire ligatures, the aesthetic result is much better than in aesthetic self ligated brackets, because their opening closing mechanism, can't be other than metal.

In addition, the present invention can be used in case when the metal door is broken and the self ligated bracket is automatically converted to a conventional one.

Furthermore, the cross-sectional shape of the invention shows a high degree of stability so that the low friction orthodontic instrument can be subjected to high mechanical loads without the risk of failure.

The invention is not limited to the illustrated embodiments.

Rather many alterations and modifications are possible within the scope of the invention.

1. A hand held low friction ligation orthodontic instrument comprising of a handle (12), on which an elongated shaft (8) extends longitudinally and is attached, the shaft comprising of a copper nickel titanium metal alloy with modified memory characteristics.

2. The low friction ligation orthodontic instrument according to claim 1, characterized in that the shaft (8) is superelastic.

3. The low friction ligation orthodontic instrument according to claim 1, characterized in that the shaft (8) is flexible.

4. The low friction ligation orthodontic instrument according to claim 1, characterized in that the shaft (8) is highly polished for reduced surface friction.

5. The low friction ligation orthodontic instrument according to claim 1, characterized in that the cross section of the shaft (8) made of copper nickel titanium alloy can be in geometric shape of circle, or square, or rectangular, or triangle, or oval, or trapezoid.
